(19) United States
(12) Patent Application Publication
(10) Pub. No.: US 2023/0087476 A1
(43) Pub. Date: Mar. 23, 2023

(54) METHODS AND APPARATUSES FOR PHOTOREALISTIC RENDERING OF IMAGES USING MACHINE LEARNING

(71) Applicant: KWAI INC., Palo Alto, CA (US)

(72) Inventors: Oliver Dayun LIU, Palo Alto, CA (US); Mengtian LI, Beijing (CN); Yi ZHENG, Beijing (CN); Haibin HUANG, Palo Alto, CA (US); Chongyang MA, Palo Alto, CA (US)

(73) Assignee: KWAI INC., Palo Alto, CA (US)

(21) Appl. No.: 17/478,733

(22) Filed: Sep. 17, 2021

(51) Int. Cl. G06T 3/40; G06N 3/08; G06T 5/30; G06T 5/00; G06K 9/00

(52) U.S. Cl. CPC G06T 3/4046; G06N 3/084; G06T 5/30; G06T 5/004; G06K 9/00248; G06T 2207/20084; G06T 2207/20081

(57) ABSTRACT

A neural network training method, an image processing method, and apparatuses thereof are provided. The neural network training method includes obtaining a first domain image and a second domain image, where the first domain image and the second domain image are unpaired images in different domains; obtaining a scaled first domain image by scaling, at an iteration, the first domain image; obtaining a training patch by cropping the scaled first domain image, where each training patch has a same number of pixels with different contents; inputting the training patch into the neural network at the iteration, and outputting an output patch; calculating a contrastive loss based on a query sub-patch and negative sub-patches selected from the training patch and a corresponding positive sub-patch selected from the output patch; and updating model parameters of the neural network based on the contrastive loss and a generative adversarial network loss.

### FIELD

The present application relates to photorealistic rendering of images, and in particular but not limited to, photorealistic rendering of images using machine learning.

### BACKGROUND

Rendering is a process of transforming a 3D digital model into a 2D image. Images rendered by using different rendering methods, techniques, and adjustments to parameters may result in different styles, such as cartoon style commonly used in games and real style used in movies. Photorealistic rendering emphasizes that a rendering result needs to retain high realism, thus making users believe that the rendering result is a real image.

Photorealistic rendering may be applied in a variety of scenarios, such as scenarios for producing entertainment contents. For example, a realistic-looking video of a celebrity can be produced by creating a digital avatar, driving the digital avatar through parameter editing, and then rendering the digital avatar through photorealistic rendering, while the realistic-looking video does not rely on capturing the actual motion of the celebrity. This method can greatly reduce the cost of hiring celebrities for shooting, while at the same time bringing forth stronger capabilities in producing contents. Therefore, photorealistic rendering has a very wide range of application prospects and high commercial value.

However, existing photorealistic rendering methods of digital avatar images require high-precision data collection and extremely high computing power. As a result, it is hard to produce sufficiently realistic rendering results.

### SUMMARY

The present disclosure provides examples of techniques relating to photorealistic rendering of images based on unsupervised learning, which requires only a small amount of data.

According to a first aspect of the present disclosure, there is provided a method for training a neural network. The method may include obtaining a first domain image and a second domain image, where the first domain image and the second domain image are unpaired images in different domains. Additionally, the method may include obtaining a scaled first domain image by scaling, at an iteration, the first domain image. Further, the method may include obtaining a training patch by cropping the scaled first domain image. Moreover, the method may include inputting the training patch into the neural network at the iteration and outputting an output patch.

According to a second aspect of the present disclosure, a method for processing an image is provided. The method includes obtaining a face-aligned image by transforming an original image using a transformation matrix and obtaining a coordinated mask image by transforming a mask image created in the same space as the face-aligned image using an inverse matrix of the transformation matrix.

Further, the method includes obtaining an eroded mask image by eroding the coordinated mask image, inputting the face-aligned image into a neural network, outputting an output image, and obtaining a back-projected output image by back projecting the output image using the inverse matrix, where the neural network is trained by patch-wise contrastive learning based on unpaired images in different domains.

Moreover, the method includes generating a final image based on pixel values in the eroded mask image, the back-projected output image, and the original image.

According to a third aspect of the present disclosure, there is provided an apparatus for training a neural network. The apparatus may include one or more processors and a memory configured to store instructions executable by the one or more processors. The one or more processors, upon execution of the instructions, are configured to obtain a first domain image and a second domain image, where the first domain image and the second domain image are unpaired images in different domains.

Further, the one or more processors are configured to obtain a scaled first domain image by scaling, at an iteration, the first domain image, obtain a training patch by cropping the scaled first domain image, input the training patch into the neural network at the iteration, and output an output patch.

According to a fourth aspect of the present disclosure, there is provided an apparatus for processing an image. The apparatus may include one or more processors and a memory configured to store instructions executable by the one or more processors.

Further, the one or more processors, upon execution of the instructions, are configured to perform acts including: obtaining a face-aligned image by transforming an original image using a transformation matrix, obtaining a coordinated mask image by transforming a mask image created in the same space as the face-aligned image using an inverse matrix of the transformation matrix, obtaining an eroded mask image by eroding the coordinated mask image, inputting the face-aligned image into a neural network, outputting an output image, and obtaining a back-projected output image by back projecting the output image using the inverse matrix, where the neural network is trained by patch-wise contrastive learning based on unpaired images in different domains.

Moreover, the one or more processors are configured to perform acts including generating a final image based on pixel values in the eroded mask image, the back-projected output image, and the original image.

According to a fifth aspect of the present disclosure, there is provided a non-transitory computer readable storage medium, including instructions stored therein. Upon execution of the instructions by one or more processors, the instructions cause the one or more processors to perform acts including: obtaining a first domain image and a second domain image, where the first domain image and the second domain image are unpaired images in different domains.

Further, the instructions cause the one or more processors to perform acts including: obtaining a scaled first domain image by scaling, at an iteration, the first domain image, obtaining a training patch by cropping the scaled first domain image, inputting the training patch into the neural network at the iteration, and outputting an output patch.

According to a sixth aspect of the present disclosure, there is provided a non-transitory computer readable storage medium, including instructions stored therein. Upon execution of the instructions by one or more processors, the instructions cause the one or more processors to perform acts including: obtaining a face-aligned image by transforming an original image using a transformation matrix and obtaining a coordinated mask image by transforming a mask image created in the same space as the face-aligned image using an inverse matrix of the transformation matrix.

Further, the instructions cause the one or more processors to perform acts including: obtaining an eroded mask image by eroding the coordinated mask image, inputting the face-aligned image into a neural network, outputting an output image, and obtaining a back-projected output image by back projecting the output image using the inverse matrix, where the neural network is trained by patch-wise contrastive learning based on unpaired images in different domains.

Moreover, the instructions cause the one or more processors to perform acts including: generating a final image based on pixel values in the eroded mask image, the back-projected output image, and the original image.

### BRIEF DESCRIPTION OF THE DRAWINGS

The application file contains drawings executed in color. Copies of this patent application publication with color drawings will be provided by the Office upon request and payment of the necessary fee.

A more particular description of the examples of the present disclosure will be rendered by reference to specific examples illustrated in the appended drawings. Given that these drawings depict only some examples and are not therefore considered to be limiting in scope, the examples will be described and explained with additional specificity and details through the use of the accompanying drawings.

FIG. 1 illustrates a comparison between a first domain image and a second domain image in accordance with some implementations of the present disclosure.

FIG. 2 illustrates examples of paired images and examples of unpaired images in accordance with some implementations of the present disclosure.

FIG. 3 illustrates a first domain image in accordance with some implementations of the present disclosure.

FIG. 4 illustrates a real person's photo in the second domain in accordance with some implementations of the present disclosure.

FIG. 5 illustrates an input image and its corresponding output image generated using contrastive learning in accordance with some implementations of the present disclosure.

FIG. 6A illustrates examples of patches used as inputs into a neural network in accordance with some implementations of the present disclosure.

FIG. 6B illustrates examples of output patches respectively corresponding to the input patches illustrates in FIG. 6A using unsupervised learning in accordance with some implementations of the present disclosure.

FIG. 7 illustrates an output image obtained during a training process based on contrastive learning and patch-wise input in accordance with some implementations of the present disclosure.

FIGS. 8A-8C illustrate three unprocessed first domain images in accordance with some implementations of the present disclosure.

FIGS. 9A-9C illustrate three processed first domain images based on the three unprocessed first domain images illustrated in FIGS. 8A-8C in accordance with some implementations of the present disclosure.

FIGS. 10A-10C illustrate three unprocessed second domain images in accordance with some implementations of the present disclosure.

FIGS. 11A-11C illustrate three processed second domain images based on the three unprocessed second domain images illustrated in FIGS. 10A-10C in accordance with some implementations of the present disclosure.

FIGS. 12A-12D illustrate examples of input images and corresponding output images of a neural network that is trained in accordance with some implementations of the present disclosure.

FIG. 13 illustrates a neural network structure for generating patch-wise contrastive loss in accordance with some implementations of the present disclosure.

FIG. 14 illustrates an example of a query sub-patch, a positive sub-patch, and negative sub-patches in accordance with some implementations of the present disclosure.

FIG. 15 is a flowchart illustrating some steps in an exemplary process of training a neural network in accordance with some implementations of the present disclosure.

FIG. 16 is a flowchart illustrating an exemplary process of back projecting an output image generated by the neural network trained according to steps illustrated in FIG. 15 to an original image in accordance with some implementations of the present disclosure.

FIG. 17 is a block diagram illustrating an image processing system in accordance with some implementations of the present disclosure.

FIG. 18 is a flowchart illustrating steps of calculating a contrastive loss in an exemplary process of training a neural network in accordance with some implementations of the present disclosure.

FIG. 19 is a flow chart illustrating steps of calculating a generative adversarial network (GAN) loss and updating model parameters of a neural network in an exemplary process of training the neural network in accordance with some implementations of the present disclosure.

### DETAILED DESCRIPTION

Reference will now be made in detail to specific implementations, examples of which are illustrated in the accompanying drawings. In the following detailed description, numerous non-limiting specific details are set forth in order to assist in understanding the subject matter presented herein. But it will be apparent to one of ordinary skill in the art that various alternatives may be used. For example, it will be apparent to one of ordinary skill in the art that the subject matter presented herein can be implemented on many types of electronic devices with digital video capabilities.

Reference throughout this specification to “one embodiment,” “an embodiment,” “an example,” “some embodiments,” “some examples,” or similar language means that a particular feature, structure, or characteristic described is included in at least one embodiment or example. Features, structures, elements, or characteristics described in connection with one or some embodiments are also applicable to other embodiments, unless expressly specified otherwise.

Throughout the disclosure, the terms “first,” “second,” “third,” and etc. are all used as nomenclature only for references to relevant elements, e.g., devices, components, compositions, steps, and etc., without implying any spatial or chronological orders, unless expressly specified otherwise. For example, a “first device” and a “second device” may refer to two separately formed devices, or two parts, components, or operational states of a same device, and may be named arbitrarily.

The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. A module may include one or more circuits with or without stored code or instructions. The module or circuit may include one or more components that are directly or indirectly connected. These components may or may not be physically attached to, or located adjacent to, one another.

As used herein, the term “if” or “when” may be understood to mean “upon” or “in response to” depending on the context. These terms, if appear in a claim, may not indicate that the relevant limitations or features are conditional or optional. For example, a method may comprise steps of: i) when or if condition X is present, function or action X′ is performed, and ii) when or if condition Y is present, function or action Y′ is performed. The method may be implemented with both the capability of performing function or action X′, and the capability of performing function or action Y′. Thus, the functions X′ and Y′ may both be performed, at different times, on multiple executions of the method.

A unit or module may be implemented purely by software, purely by hardware, or by a combination of hardware and software. In a pure software implementation, for example, the unit or module may include functionally related code blocks or software components, that are directly or indirectly linked together, so as to perform a particular function.

Physics-based realistic rendering of human portraits simulates and reconstructs apparent characteristics of real objects in a specific environment by accurately collecting and reconstructing geometric information, surface material information, and environmental lighting information of the rendered object, combined with the classical lighting calculation method. Physics-based realistic rendering of human portraits can successfully simulate an effect close to the real photo.

However, physics-based realistic rendering of human portraits requires collection of geometry, texture, and illumination information in high precision. Such requirement imposes high costs for information collection and production, while insufficient accuracy in data collection may significantly reduce realism.

Additionally, physics-based realistic rendering of human portraits is an approximate simulation of material and lighting. With limited calculation power and accuracy, it is difficult to reach a high level of accuracy using an approximation solution. As result, decreased accuracy may significantly reduce the level of realism.

As existing realistic rendering techniques have strict requirements for data collecting accuracy and computing power and the results cannot reach adequate level of realism, the present disclosure provides a machine learning based method to address such issue. The present disclosure uses techniques including unsupervised learning, contrastive learning, patch-based methods, and utilization of different effective contents in each training patch, obtained by applying scaling at each iteration when training the neural network.

According to the present disclosure, during the training process, each patch inputted into the neural network at each iteration represents different contents from the corresponding first domain image resulted from scaling the first domain image based on a random scaling factor and cropping the scaled first domain image by using a fixed size. As a result, the neural network pays attention to style transformation in local areas and leaves some global information unchanged, such as identity information, thus eliminating artifacts in outputs.

Additionally, in the present disclosure, contrastive learning implemented based on sub-patches within patches highly retains local geometry information in output patches because inputs of the neural network are patches instead of a whole image. Furthermore, contrastive learning emphasizes on commonalities between different domains, thus smoothening transition between different domains. Moreover, given a small number of images that can be used for training, a comparatively large number of training patches may be obtained and be used during the training process, thus solving the problem of lacking training samples.

In the present disclosure, photorealistic rendering is implemented through machine learning using neural networks through the means of style transfer. Style transfer is a process of presenting images in a first domain in another style from a second domain through machine learning.

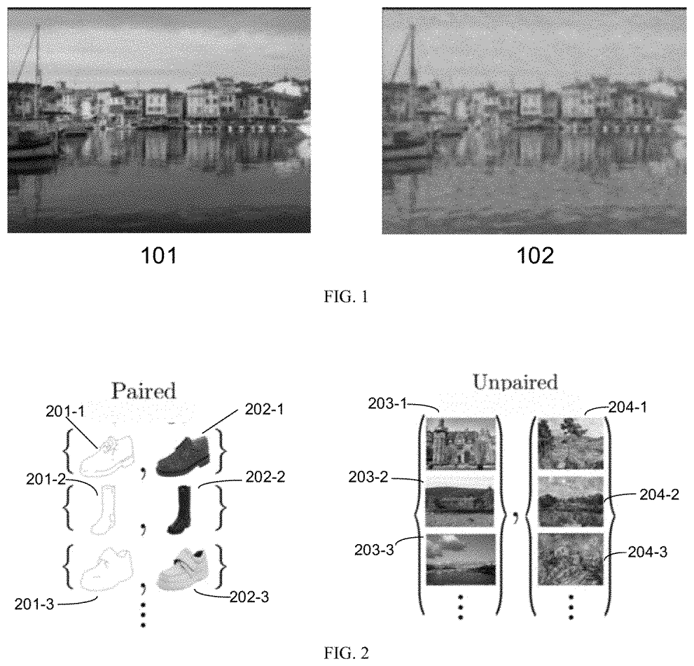

FIG. 1 illustrates a comparison between a first domain image and a second domain image in accordance with some implementations of the present disclosure. For example, in FIG. 1, a first domain image 101 has been style transferred into a second domain image 102, which has a style closely resembling Monet's painting. In this example, the first domain consists of landscape images taken in real life and the second domain consist of Monet's paintings. As shown in FIG. 1, contents in the first domain image 101 respectively correspond to contents in the second domain image 102. Thus, the second domain image 102 is a stylized image of the first domain image 101.

Style transfer can be realized through either supervised learning or unsupervised learning. FIG. 2 illustrates examples of paired images and examples of unpaired images in accordance with some implementations of the present disclosure. In supervised learning, training data consists of paired images. In unsupervised learning, training data consists of unpaired images.

As shown in FIG. 2, in supervised learning, training data may include paired images 201-1 and 202-1, 201-2 and 202-2, and 201-3 and 202-3. In one example, training data in supervised learning consists of paired images 201-1 and 202-1, 201-2 and 202-2, and 201-3 and 202-3. For example, the paired images 201-1 and 202-1 respectively represent the same dress shoe in different styles. Paired images 201-2 and 202-2 respectively represent the same boot in different styles. Paired images 201-3 and 202-3 respectively represent the same casual shoe in different styles. The images 201-1, 201-2, and 201-3 belong to one style while the images 202-1, 202-2, and 202-3 belong to another style. Images 201-1, 201-2, and 201-3 represent input images in supervised learning, and images 202-1, 202-2, and 202-3 are ground truth respectively corresponding to or matching the images 201-1, 202-1, and 203-1.

As shown in FIG. 2, in unsupervised learning, training data may include unpaired images 203-1, 203-2, 203-3, 204-1, 204-2, and 204-3. In one example, training data consists of unpaired images 203-1, 203-2, 203-3, 204-1, 204-2, and 204-3. Images 203-1, 203-2, and 203-3 are input images. Images 204-1, 204-2, and 204-3 are images from a second domain different from the input images. As shown in FIG. 2, unpaired images 203-1, 203-2, 203-3, 204-1, 204-2, and 204-3 respectively represent different landscapes. There is no corresponding or matching relationship between the input images 203-1, 203-2, 203-3 and the images 204-1, 204-2, and 204-3. Images 203-1, 203-2, 203-3 are represented in one style, such as real landscape photos. Images 204-1, 204-2, and 204-3 are represented in another style, such as paintings.

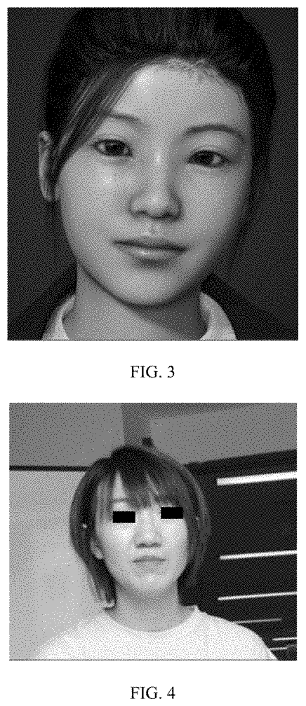

In photorealistic rendering, it is very difficult to obtain matching or paired data. It is time-consuming and labor-intensive to implement operations including: generating a large number of different, yet detailed digital avatar models; driving the generated digital avatar models; and then rendering the results in high fidelity. At the same time, many digital avatar based services or business are tied to celebrities, while hiring celebrities to collect their data is very pricy. To solve this problem, examples in the present disclosure leverage unsupervised learning for style transfer, training on only a small number of unpaired images which can be easily obtained, as shown in FIGS. 3-4. FIG. 3 illustrates a first domain image in accordance with some implementations of the present disclosure. The image shown in FIG. 3 may be a digital avatar image obtained from a game engine. As shown in FIG. 3, the digital avatar image may illustrate a face of a digital avatar. FIG. 4 illustrates a real person's photo in the second domain in accordance with some implementations of the present disclosure. The real person's photo may be a selfie as shown in FIG. 4. The two black blocks located on eye area in FIG. 4 are only used for privacy purposes and do not limit the scope of the present disclosure.

In the present disclosure, unsupervised learning is achieved through use of contrastive learning. After obtaining the corresponding output image, a contrastive loss is calculated based on a generated output patch selected from the output image, its corresponding input patch, and other patches in the input image, so that the output patch closely resembles its corresponding input patch, while also differing from any other patches in the image.

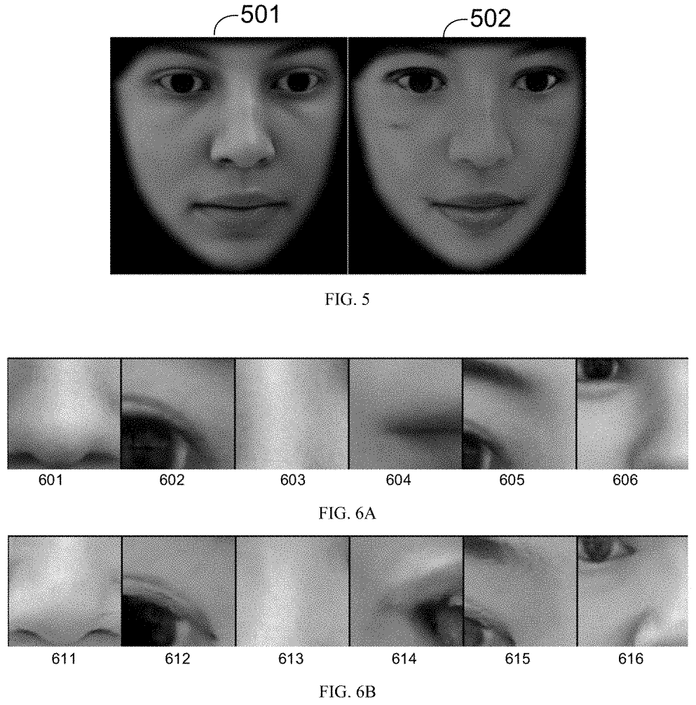

However, by using contrastive learning only, the identity information of the digital avatar cannot be retained in the output image because during training, the images from the first domain and the second domain contains different identity information. FIG. 5 illustrates an input image and its corresponding output image generated using contrastive learning in accordance with some implementations of the present disclosure. As shown in FIG. 5, image 501 is an input image of a neural network, and image 502 is the corresponding output image by using only contrastive learning. The image 502 does not retain identity information of the digital avatar shown in image 501 and the face in the image 502 appears different from the face in image 501.

To solve such problem, a patch-based method is implemented in some examples. During the training process, instead of using a whole image as the input data to the neural network, a patch is obtained by cropping the image in a dataset. At an iteration, the patch is used as input data and inputted into the neural network. Thus, the network may pay more attention to style transformation in local areas and leave some global information unchanged, such as identity information.

FIG. 6A illustrates examples of patches used as inputs into a neural network in accordance with some implementations of the present disclosure. FIG. 6B illustrates examples of output patches respectively corresponding to the input patches illustrates in FIG. 6A using unsupervised learning in accordance with some implementations of the present disclosure. The output patches in FIG. 6B respectively retain local geometry information in the corresponding patches illustrated in FIG. 6A. For example, patch 601 in FIG. 6A is a patch representing part of a nose of a digital avatar and is an input patch of the neural network. Patch 611 is an output patch corresponding to the patch 601 by using the unsupervised learning and retains the local geometry information of the nose.

Furthermore, patches 602, 603, 604, 605, and 606 are respectively examples of input patches representing parts of the face of the digital avatar and patches 612, 613, 614, 615, and 616 are the corresponding output patches resulted from the input patch 602, 603, 604, 605, or 606 using the unsupervised learning. As a result, the output patches 612, 613, 614, 615, and 616 highly preserve the local geometry information of the digital avatar because inputs of the neural network are patches instead of a whole image.

In some examples, because the input and output of the neural network are patches instead of whole images, the contrastive learning is implemented based on sub-patches within patches.

FIG. 14 illustrates an example of a query sub-patch, a positive sub-patch, and negative sub-patches in accordance with some implementations of the present disclosure. As shown in FIG. 14, patch 1401 is a training patch selected from a first domain image. The training patch 1401 may be used as an input patch inputted to the neural network for unsupervised learning. Patch 1402 may be an output patch generated by the neural network when the input data of the neural network is patch 1401. Patches 1401 and 1402 respectively include a plurality of sub-patches. A query sub-patch, shown in FIG. 14, is selected from patch 1401. A positive sub-patch corresponding to the query sub-patch is selected from patch 1402. The query sub-patch and the positive sub-patch may be respectively located at the same location in patch 1401 and patch 1402.

In some examples, multiple negative sub-patches different than the query sub-patch may be selected from patch 1401. For example, the multiple negative sub-patches may be located at different locations than the query sub-patch in patch 1401. Based on the selected query sub-patch, positive sub-patch, and multiple negative sub-patches, a contrastive loss may be calculated by using the contrastive loss function, which learns an embedding or an encoder that associates corresponding sub-patches to each other while disassociating them from others. As a result, the encoder learns to emphasize on commonalities between different domains, thus smoothening transition between different domains. Additionally, given a small number of images that can be used for training, a comparatively large number of training patches may be obtained and be used during the training process, thus solving the problem of lacking training samples.

FIG. 13 illustrates a neural network structure for generating patch-wise contrastive loss in accordance with some implementations of the present disclosure. Query sub-patch and multiple negative sub-patches are inputted into an encoder 1301 and a multilayer perceptron (MLP) network 1302. Positive sub-patch is inputted into another encoder 1303 and another MLP network 1304. And then the patch-wise contrastive loss is generated based on outputs of the MLP networks 1302 and 1304.

In some examples, in addition to the contrastive loss calculated based on the selected query sub-patch, multiple negative sub-patches, and positive sub-patch, an adversarial loss, such as a GAN loss, is also calculated, and model parameters of the neural network are updated based on both the contrastive loss and the adversarial loss. The use of the adversarial loss improves visual similarity between output patch and patch in a target domain, such as the second domain.

In some examples, after a second domain image is scaled with a scaling factor, a second domain patch is selected by cropping the scaled second domain image. The selected second domain patch may have a size of 128×128, etc. Then, a patch is selected, for example, at a probability of 50%, from the second domain patch or an output patch corresponding to a training patch. The selected patch is inputted into a discriminator network which outputs a value between 0 and 1. The second domain patch is labeled 1 and the output patch in the first domain is labeled 0. Then a GAN loss is obtained based on the outputted value.

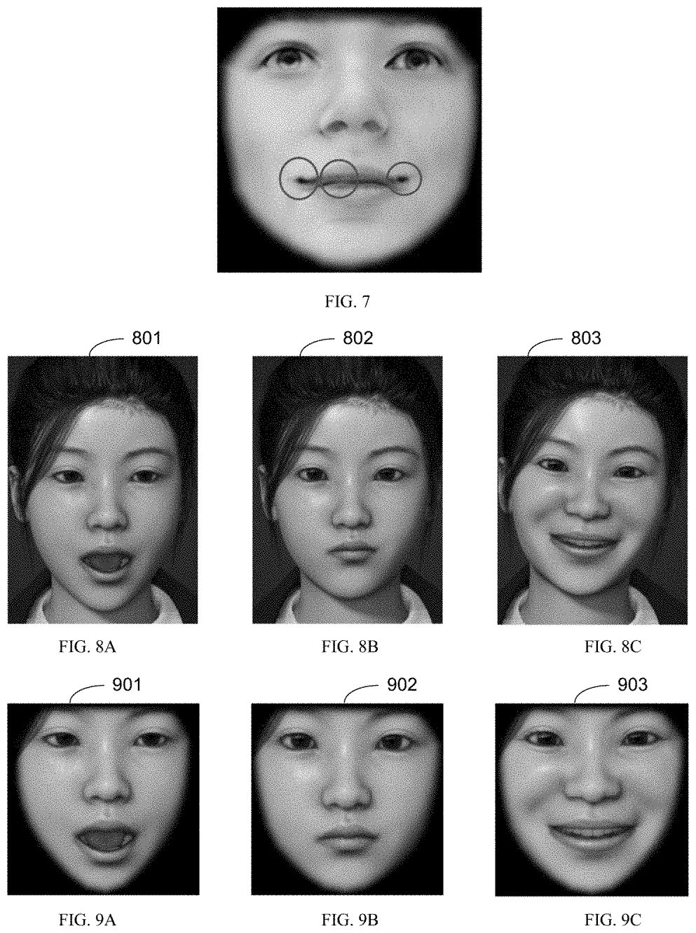

The training method based on contrastive learning and patch-wise input emphasizes on learning local style transition while sometime pays less attention to the consistency of the entire image. As a result, artifacts or flaws may appear on the output image. FIG. 7 illustrates an output image obtained during a training process based on contrastive learning and patch-wise input in accordance with some implementations of the present disclosure. Artifacts are circled as shown in FIG. 7 due to the emphasis on learning local style transition.

To solve such problem, before obtaining a training patch as an input patch, the corresponding image in the first domain may be scaled at each iteration. After the corresponding image in the first domain is scaled with a pre-determined scaling factor, one or more patches are cropped from the scaled image. The scaling factor may be a random value in a pre-determined range. For example, the scaling factor may be a random value between 0.5 and 2.

In some examples, the one or more patches may be of a same pixel size, such as 128×128, and the number of the one or more patched cropped from the scaled image may be pre-determined. For example, at each iteration, after each time the corresponding image is scaled, 24 patches of a size of 128×128 are cropped from the scaled image and used as a batch of input data inputted to the neural network. Note that the number of patches in a batch may be adjusted or updated if needed.

In some examples, a patch may be cropped based on a starting position on the scaled image and the size of each patch. For example, the starting position is a pre-determined coordinate position in the scaled image, and the patch may be obtained by cropping a 128×128 patch at the coordinate position.

In some examples, the scaling factor used each time for scaling may be respectively different value. For example, after scaling the corresponding first domain image with a first scaling factor, a first patch may be cropped from the scaled image scaled with the first scaling factor. The first patch may be located at a first location. At a subsequent iteration, after scaling the corresponding first domain image with a second scaling factor that is different from the first scaling factor, a second patch may be then cropped from the scaled image scaled with the second scaling factor. The second patch may be located at a location corresponding to the first location. The first patch and the second patch may have a same size of 128×128. Because the first scaling factor is different from the second scaling factor, the first patch and the second patch may therefore contain different contents. The first patch and the second patch are respectively inputted to the neural network at different iterations. As a result, data inputted into the neural network at each iteration are patches containing different content, and the neural network learns both local and global information.

FIGS. 8A-8C illustrate three unprocessed first domain images in accordance with some implementations of the present disclosure. First domain images may include processed first domain images and unprocessed first domain images. The three unprocessed first domain images 801, 802, and 803 respectively show three digital avatar images of a same digital avatar with three different facial expressions and poses in a game engine. A pose may indicate a face orientation.

FIGS. 9A-9C illustrate three processed first domain images based on the three unprocessed first domain images illustrated in FIGS. 8A-8C in accordance with some implementations of the present disclosure. The three processed first domain images 901, 902, and 903 are images in the first domain representing a same style of digital avatar images. The three processed first domain images 901, 902, and 903 may be processed through face alignment, central cropping, scaling, etc. Scaling may be performed on either unprocessed first domain images or processed first domain images.

For example, face alignment may be performed on unprocessed first domain image 801 to obtain an aligned image and central cropping is then performed on the aligned image to obtain processed first domain image 901 in which the face is centrally positioned. Furthermore, scaling may be performed on the processed first domain image 901 with a random scaling factor. Subsequently, one or more training patches are cropped from the processed first domain image 901 that has been scaled, and respectively inputted into the neural network for training.

Similarly, face alignment may be performed on unprocessed first domain image 802 to obtain an aligned image. Then, central cropping is performed on the aligned image to obtain processed first domain image 902 in which the face is centrally positioned. Furthermore, face alignment may be performed on unprocessed first domain image 803 to obtain an aligned image. Then, central cropping is performed on the aligned image to obtained processed first domain image 903 in which the face is centrally positioned. One or more training patches are respectively cropped from processed first domain images 902 and 903 that have been scaled, and inputted into the neural network for training.

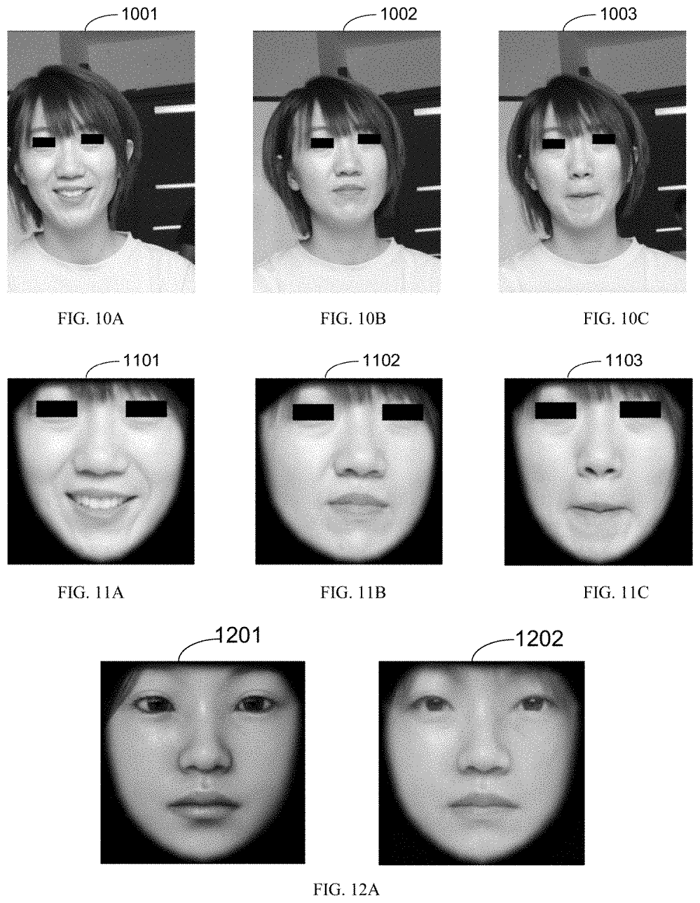

FIGS. 10A-10C illustrate three unprocessed second domain images in accordance with some implementations of the present disclosure. Second domain images may include unprocessed second domain images and processed second domain images. The three unprocessed second domain images 1001, 1002, and 1003 respectively show three real-person photos of a same person with three different facial expressions and poses.

FIGS. 11A-11C illustrate three processed second domain images based on the three unprocessed second domain images illustrated in FIGS. 10A-10C in accordance with some implementations of the present disclosure. The two black blocks located on eye area in each of FIGS. 10A-10C and 11A-11C are only used for privacy purposes and do not limit the scope of the present disclosure. The three processed second domain images 1101, 1102, and 1103 are images in the second domain representing a same style of real-person photos. The three processed second domain images 1101, 1102, and 1103 may be processed through face alignment, central cropping, scaling, etc. Scaling may be performed on either unprocessed second domain images or processed second domain images.

For example, face alignment may be performed on unprocessed second domain image 1001 to obtain an aligned image. Then, central cropping is performed on the aligned image to obtained processed second domain image 1101 in which the face is centrally positioned. Both processed first domain image 901 and processed second domain image 1101 may be scaled using the same scaling factor.

Similarly, face alignment may be performed on unprocessed second domain image 1002 to obtain an aligned image. Then, central cropping is performed on the aligned image to obtain processed second domain image 1102 in which the face is centrally positioned. Both processed first domain image 902 and processed second image 1102 may be scaled using the same scaling factor.

Similarly, face alignment may be performed on unprocessed second domain image 1003 to obtain an aligned image. Then, central cropping is performed on the aligned image to obtained processed second domain image 1103 in which the face is centrally positioned. Both processed first domain image 903 and processed second domain image 1103 may be scaled using the same scaling factor.

After the neural network is trained by patch-wise contrastive learning based on unpaired images in different domains, any images belonging to the first domain may be used as input images for the trained neural network and output images in the second domain may be generated by the trained neural network. The trained neural network can then become a quick realistic renderer of digital avatar images which can process images in batches.

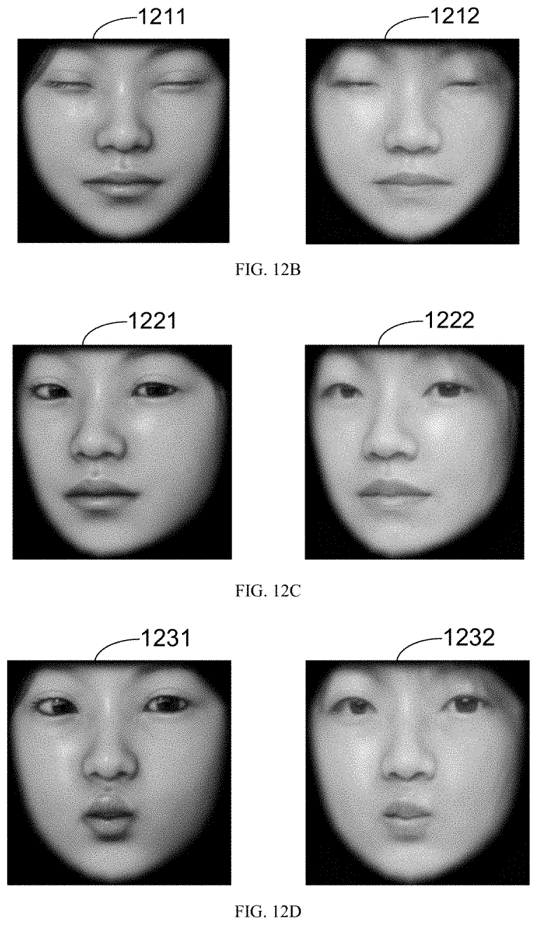

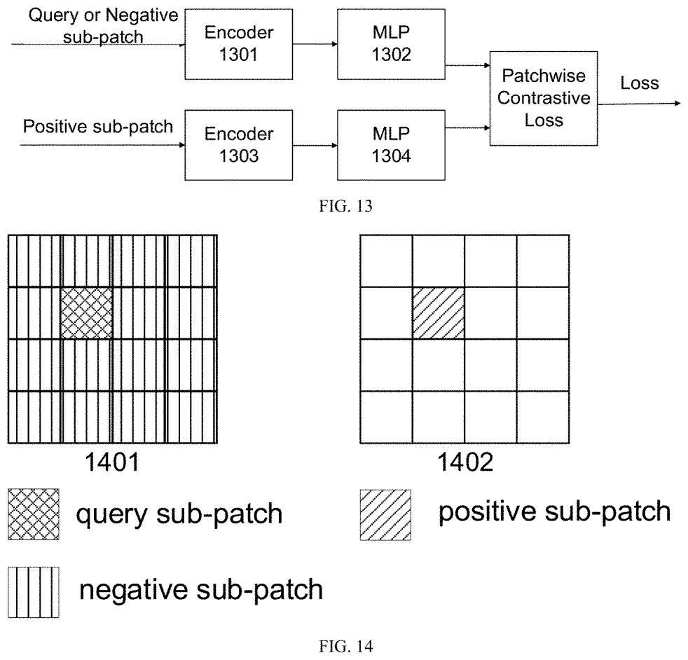

FIGS. 12A-12D illustrate examples of input images and corresponding output images of a neural network that is trained in accordance with some implementations of the present disclosure.

As shown in FIG. 12A, a digital avatar image 1201 is used as an input image of the trained neural network and an output image 1202 is an output image corresponding to the digital avatar image 1201. The output image 1202 appears more like a real-person image and retains identity information of the digital avatar.

Similarly, as shown in FIG. 12B, a digital avatar image 1211 is used as an input image of the trained neural network and an output image 1212 is an output image corresponding to the digital avatar image 1211. The output image 1212 appears more like a real-person image and retains identity information of the digital avatar.

Similarly, as shown in FIG. 12C, a digital avatar image 1221 is used as an input image of the trained neural network and an output image 1222 is an output image corresponding to the digital avatar image 1221. The output image 1222 appears more like a real-person image and retains identity information of the digital avatar.

Similarly, as shown in FIG. 12D, a digital avatar image 1231 is used as an input image of the trained neural network and an output image 1232 is an output image corresponding to the digital avatar image 1231. The output image 1232 appears more like a real-person image and retains identity information of the digital avatar.

In some examples, the implementation of the training process in accordance with the present disclosure can use the PyTorch deep learning framework for neural network training, and use the C++ language for algorithm integration. After the neural network training is completed, for a digital avatar image with a resolution of 512×512, the realistic rendering of the image on a server computer equipped with an NVIDIA RTX 1080Ti graphics card can be completed within 0.24 seconds. Thus, the examples of the present disclosure can quickly perform realistic rendering of digital avatars by maintaining high realism and identity information of the digital avatar, and generate an output image with no artifacts. At the same time, the methods of the present disclosure do not require high-precision data collection or high computing power.

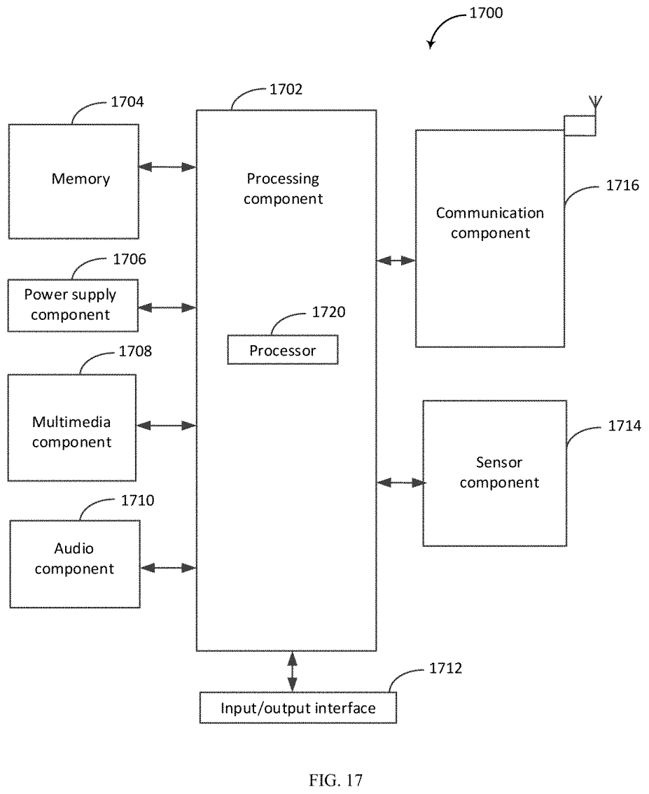

FIG. 17 is a block diagram illustrating an image processing system in accordance with some implementations of the present disclosure. The system 1700 may be a terminal, such as a mobile phone, a tablet computer, a digital broadcast terminal, a tablet device, or a personal digital assistant.

As shown in FIG. 17, the system 1700 may include one or more of the following components: a processing component 1702, a memory 1704, a power supply component 1706, a multimedia component 1708, an audio component 1710, an input/output (I/O) interface 1712, a sensor component 1714, and a communication component 1716.

The processing component 1702 usually controls overall operations of the system 1700, such as operations relating to display, a telephone call, data communication, a camera operation and a recording operation. The processing component 1702 may include one or more processors 1720 for executing instructions to complete all or a part of steps of the above method. The processors 1720 may include CPU, GPU, DSP, or other processors. Further, the processing component 1702 may include one or more modules to facilitate interaction between the processing component 1702 and other components. For example, the processing component 1702 may include a multimedia module to facilitate the interaction between the multimedia component 1708 and the processing component 1702.

The memory 1704 is configured to store different types of data to support operations of the system 1700. Examples of such data include instructions, contact data, phonebook data, messages, pictures, videos, and so on for any application or method that operates on the system 1700. The memory 1704 may be implemented by any type of volatile or non-volatile storage devices or a combination thereof, and the memory 1704 may be a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic disk, or a compact disk.

The power supply component 1706 supplies power for different components of the system 1700. The power supply component 1706 may include a power supply management system, one or more power supplies, and other components associated with generating, managing and distributing power for the system 1700.

The multimedia component 1708 includes a screen providing an output interface between the system 1700 and a user. In some examples, the screen may include a Liquid Crystal Display (LCD) and a Touch Panel (TP). If the screen includes a touch panel, the screen may be implemented as a touch screen receiving an input signal from a user. The touch panel may include one or more touch sensors for sensing a touch, a slide, and a gesture on the touch panel. The touch sensor may not only sense a boundary of a touching or sliding actions, but also detect duration and pressure related to the touching or sliding operation. In some examples, the multimedia component 1708 may include a front camera and/or a rear camera. When the system 1700 is in an operation mode, such as a shooting mode or a video mode, the front camera and/or the rear camera may receive external multimedia data.

The audio component 1710 is configured to output and/or input an audio signal. For example, the audio component 1710 includes a microphone (MIC). When the system 1700 is in an operating mode, such as a call mode, a recording mode and a voice recognition mode, the microphone is configured to receive an external audio signal. The received audio signal may be further stored in the memory 1704 or sent via the communication component 1716. In some examples, the audio component 1710 further includes a speaker for outputting an audio signal.

The I/O interface 1712 provides an interface between the processing component 1702 and a peripheral interface module. The above peripheral interface module may be a keyboard, a click wheel, a button, or the like. These buttons may include but not limited to, a home button, a volume button, a start button, and a lock button.

The sensor component 1714 includes one or more sensors for providing a state assessment in different aspects for the system 1700. For example, the sensor component 1714 may detect an on/off state of the system 1700 and relative locations of components. For example, the components are a display and a keypad of the system 1700. The sensor component 1714 may also detect a position change of the system 1700 or a component of the system 1700, presence or absence of a contact of a user on the system 1700, an orientation or acceleration/deceleration of the system 1700, and a temperature change of system 1700. The sensor component 1714 may include a proximity sensor configured to detect presence of a nearby object without any physical touch. The sensor component 1714 may further include an optical sensor, such as a CMOS or CCD image sensor used in an imaging application. In some examples, the sensor component 1714 may further include an acceleration sensor, a gyroscope sensor, a magnetic sensor, a pressure sensor, or a temperature sensor.

The communication component 1716 is configured to facilitate wired or wireless communication between the system 1700 and other devices. The system 1700 may access a wireless network based on a communication standard, such as WiFi, 4G, or a combination thereof. In an example, the communication component 1716 receives a broadcast signal or broadcast related information from an external broadcast management system via a broadcast channel. In an example, the communication component 1716 may further include a Near Field Communication (NFC) module for promoting short-range communication. For example, the NFC module may be implemented based on Radio Frequency Identification (RFID) technology, infrared data association (IrDA) technology, Ultra-Wide Band (UWB) technology, Bluetooth (BT) technology and other technology.

In an example, the system 1700 may be implemented by one or more of Application Specific Integrated Circuits (ASIC), Digital Signal Processors (DSP), Digital Signal Processing Devices (DSPD), Programmable Logic Devices (PLD), Field Programmable Gate Arrays (FPGA), controllers, microcontrollers, microprocessors, or other electronic elements to perform the above method.

A non-transitory computer readable storage medium may be, for example, a Hard Disk Drive (HDD), a Solid-State Drive (SSD), Flash memory, a Hybrid Drive or Solid-State Hybrid Drive (SSHD), a Read-Only Memory (ROM), a Compact Disc Read-Only Memory (CD-ROM), a magnetic tape, a floppy disk, etc.

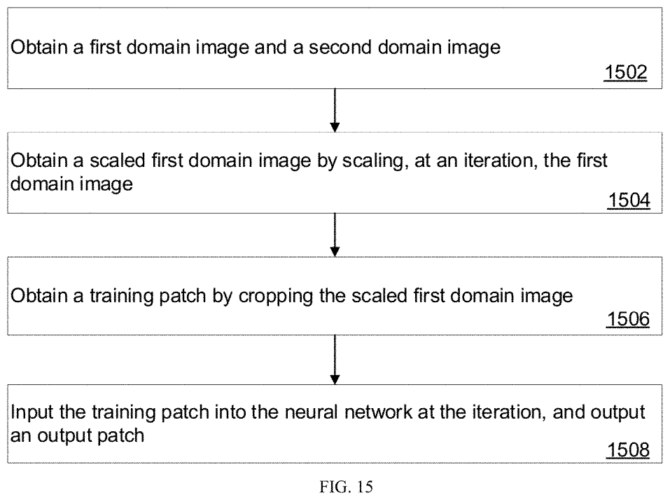

FIG. 15 is a flowchart illustrating some steps in an exemplary process of training a neural network in accordance with some implementations of the present disclosure.

In step 1502, the processor 1720 obtains a first domain image and a second domain image.

In some examples, the first domain image and the second domain image are unpaired images in different domains.

In step 1504, the processor 1720 obtains a scaled first domain image by scaling, at an iteration, the first domain image.

In step 1506, the processor 1720 obtains a training patch by cropping the scaled first domain image.

In step 1508, the processor 1720 inputs the training patch into the neural network at the iteration, and outputs an output patch.

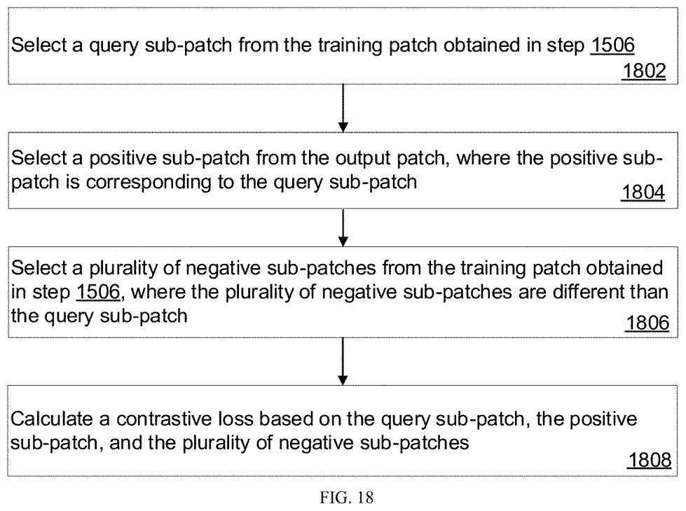

FIG. 18 is a flowchart illustrating steps of calculating a contrastive loss in an exemplary process of training a neural network in accordance with some implementations of the present disclosure.

In step 1802, the processor 1720 selects a query sub-patch from the training patch obtained in step 1506.

In step 1804, the processor 1720 selects a positive sub-patch from the output patch, where the positive sub-patch is corresponding to the query sub-patch.

In step 1806, the processor 1720 selects a plurality of negative sub-patches from the training patch obtained in step 1506, where the plurality of negative sub-patches are different than the query sub-patch.

In step 1808, the processor 1720 calculates a contrastive loss based on the query sub-patch, the positive sub-patch, and the plurality of negative sub-patches.

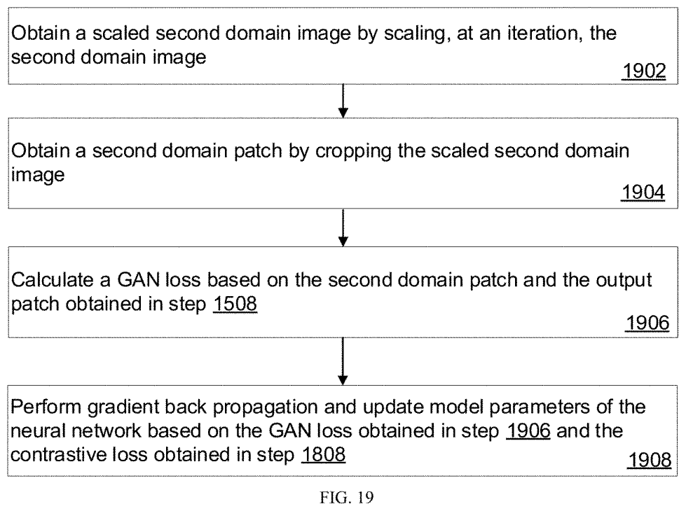

FIG. 19 is a flow chart illustrating steps of calculating a GAN loss and updating model parameters of a neural network in an exemplary process of training the neural network in accordance with some implementations of the present disclosure.

In step 1902, the processor 1720 obtains a scaled second domain image by scaling, at an iteration, the second domain image. The scaled first domain image obtained in step 1504 and the scaled second domain image may be scaled with the same scaling factor.

In step 1904, the processor 1720 obtains a second domain patch by cropping the scaled second domain image.

In step 1906, the processor 1720 calculates a GAN loss based on the second domain patch and the output patch obtained in step 1508. The output patch obtained in step 1508 is an output patch corresponding to the training patch in the first domain.

In step 1908, the processor 1720 performs gradient back propagation and updates model parameters of the neural network based on the GAN loss obtained in step 1906 and the contrastive loss obtained in step 1808.

In some examples, the first domain image may include a digital avatar image and the second domain image may include a real-person photo. For examples, the first domain image may include the digital avatar image as shown in FIGS. 8A-8C. Further, the second domain image may include the real-person photo as shown in FIGS. 10A-10C. In some examples, the first domain image may include digital pet images and the second domain image may include real pet images.

In some examples, the processor 1720 may further scale the first domain image based on a random scaling factor in a pre-determined range.

In some examples, each training patch selected from the scaled first domain image may have a same number of pixels with different contents resulted from scaling the first domain image based on the random scaling factor and cropping the scaled first domain image using a fixed size.

In some examples, each training patch may indicate partial features in the first domain image including the training patch.

In some examples, the processor 1720 may further determine a starting position on the scaled first domain image and obtain the training patch according to the starting position and the same number of pixels in each training patch.

In some examples, there is provided an apparatus for training a neural network. The apparatus includes one or more processors 1720 and a memory 1704 configured to store instructions executable by the one or more processors; where the processor, upon execution of the instructions, is configured to perform a method as illustrated in FIG. 15, FIG. 18, or FIG. 19.

In some other examples, there is provided a non-transitory computer readable storage medium 1704, having instructions stored therein. When the instructions are executed by one or more processors 1720, the instructions cause the processor to perform a method as illustrated in FIG. 15, FIG. 18, or FIG. 19.

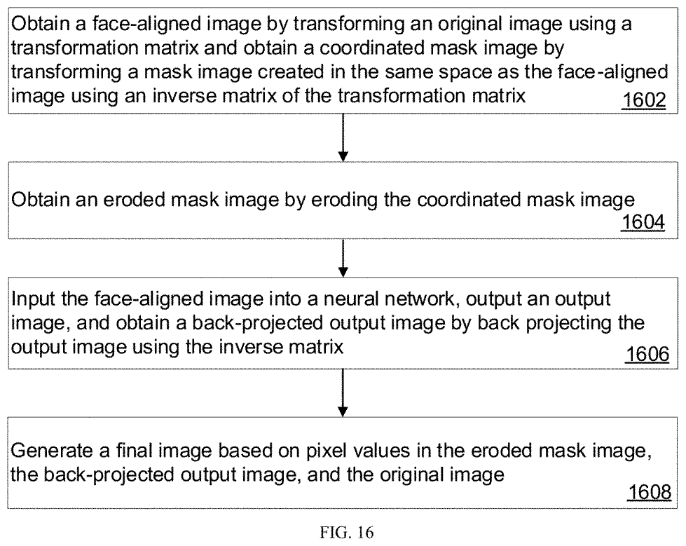

FIG. 16 is a flowchart illustrating an exemplary process of back projecting an output image generated by the neural network trained according to steps illustrated in FIG. 15 to an original image in accordance with some implementations of the present disclosure.

In step 1602, the processor 1720 obtains a face-aligned image by transforming an original image using a transformation matrix and obtains a coordinated mask image by transforming a mask image created in the same space as the face-aligned image using an inverse matrix of the transformation matrix.

In some examples, the coordinated mask image is in the same space as the original image.

In step 1604, the processor 1720 obtains an eroded mask image by eroding the coordinated mask image.

In some examples, the coordinated mask image is eroded such that pixel values at edges of the coordinated mask image are reduced to be within a pre-determined range. For example, pixel values of the mask image that is pure white are 1. After eroding, the pixel values at edges of the coordinated mask image are reduced to be within [0.95, 0.99].

In step 1606, the processor 1720 inputs the face-aligned image into a neural network, outputs an output image, and obtains a back-projected output image by back projecting the output image using the inverse matrix.

In some examples, the neural network is trained with patch-wise contrastive learning based on unpaired images in different domains according to the steps illustrated in FIG. 15.

In step 1608, the processor 1720 generates a final image based on pixel values in the eroded mask image, the back-projected output image, and the original image.

In some examples, each pixel value in the final image may be obtained by following equation:

F=M×O+(1−M)×A

where F denotes a value of a pixel in the final image, M denotes a value of a corresponding pixel in the eroded mask image, O denotes a value of a corresponding pixel in the back-projected output image, and A denotes a value of a corresponding pixel in the original image.

In some examples, there is provided an apparatus for processing an image. The apparatus includes one or more processors 1720 and a memory 1704 configured to store instructions executable by the one or more processors; where the processor, upon execution of the instructions, is configured to perform a method as illustrated in FIG. 16.

In some other examples, there is provided a non-transitory computer readable storage medium 1704, having instructions stored therein. When the instructions are executed by one or more processors 1720, the instructions cause the processor to perform a method as illustrated in FIG. 16.

The description of the present disclosure has been presented for purposes of illustration and is not intended to be exhaustive or limited to the present disclosure. Many modifications, variations, and alternative implementations will be apparent to those of ordinary skill in the art having the benefit of the teachings presented in the foregoing descriptions and the associated drawings.

The examples were chosen and described in order to explain the principles of the disclosure, and to enable others skilled in the art to understand the disclosure for various implementations and to best utilize the underlying principles and various implementations with various modifications as are suited to the particular use contemplated. Therefore, it is to be understood that the scope of the disclosure is not to be limited to the specific examples of the implementations disclosed and that modifications and other implementations are intended to be included within the scope of the present disclosure.

What is claimed is:

1. A method for training a neural network, comprising:
obtaining a first domain image and a second domain image, wherein the first domain image and the second domain image are unpaired images in different domains;
obtaining a scaled first domain image by scaling, at an iteration, the first domain image;
obtaining a training patch by cropping the scaled first domain image; and
inputting the training patch into the neural network at the iteration, and outputting an output patch.

2. The method of claim 1, wherein the first domain image comprises a digital avatar image and the second domain image comprises a real-person photo,
wherein the method further comprises: scaling the first domain image based on a random scaling factor in a pre-determined range.

3. The method of claim 2, further comprising:
selecting a query sub-patch from the training patch;
selecting a positive sub-patch from the output patch, wherein the positive sub-patch is corresponding to the query sub-patch;
selecting a plurality of negative sub-patches from the training patch, wherein the plurality of negative sub-patches are different than the query sub-patch; and
calculating a contrastive loss based on the query sub-patch, the positive sub-patch, and the plurality of negative sub-patches.

4. The method of claim 3, further comprising:
obtaining a scaled second domain image by scaling, at the iteration, the second domain image based on the random scaling factor;
obtaining a second domain patch by cropping the scaled second domain image;
calculating a generative adversarial network (GAN) loss based on the output patch and the second domain patch; and
updating model parameters of the neural network based on the contrastive loss and the GAN loss.

5. The method of claim 2, wherein each training patch selected from the scaled first domain image has a same number of pixels with different contents resulted from scaling the first domain image based on the random scaling factor and cropping the scaled first domain image by using a fixed size.

6. The method of claim 5, wherein each training patch indicates partial features in the first domain image comprising the training patch.

7. The method of claim 5, wherein obtaining the training patch by cropping the scaled first domain image comprises:
determining a starting position on the scaled first domain image; and
obtaining the training patch according to the starting position and the same number of pixels in each training patch.

8. A method for processing an image, comprising:
obtaining a face-aligned image by transforming an original image using a transformation matrix and obtaining a coordinated mask image by transforming a mask image using an inverse matrix of the transformation matrix;
obtaining an eroded mask image by eroding the coordinated mask image;
inputting the face-aligned image into a neural network, outputting an output image, and obtaining a back-projected output image by back projecting the output image using the inverse matrix, wherein the neural network is trained by patch-wise contrastive learning based on unpaired images in different domains; and
generating a final image based on pixel values in the eroded mask image, the back-projected output image, and the original image.

9. The method of claim 8, wherein each pixel value in the final image is obtained by following equation:
F=M×O+(1−M)×A
wherein F denotes a value of a pixel in the final image, M denotes a value of a corresponding pixel in the eroded mask image, O denotes a value of a corresponding pixel in the back-projected output image, and A denotes a value of a corresponding pixel in the original image.

10. The method of claim 8, wherein the neural network is trained with patch-wise contrastive learning based on unpaired images in different domains comprising:
obtaining a first domain image and a second domain image, wherein the first domain image and the second domain image are unpaired images in different domains;
obtaining a scaled first domain image by scaling, at an iteration, the first domain image;
obtaining a training patch by cropping the scaled first domain image; and
inputting the training patch into the neural network at the iteration, and outputting an output patch.

11. The method of claim 10, wherein the first domain image comprises a digital avatar image and the second domain image comprises a real-person photo,
wherein the neural network is further trained by scaling the first domain image based on a random scaling factor in a pre-determined range.

12. The method of claim 11, wherein the neural network is further trained by:
selecting a query sub-patch from the training patch;
selecting a positive sub-patch from the output patch, wherein the positive sub-patch is corresponding to the query sub-patch;
selecting a plurality of negative sub-patches from the training patch, wherein the plurality of negative sub-patches are different than the query sub-patch;
calculating a contrastive loss based on the query sub-patch, the positive sub-patch, and the plurality of negative sub-patches;
obtaining a scaled second domain image by scaling, at the iteration, the second domain image based on the random scaling factor;
obtaining a second domain patch by cropping the scaled second domain image;
calculating a generative adversarial network (GAN) loss based on the output patch and the second domain patch; and
updating model parameters of the neural network based on the contrastive loss and the GAN loss.

13. The method of claim 11, wherein each training patch selected from the scaled first domain image has a same number of pixels with different contents resulted from scaling the first domain image based on the random scaling factor and cropping the scaled first domain image by using a fixed size.

14. An apparatus for training a neural network, comprising:
one or more processors; and
a memory configured to store instructions executable by the one or more processors;
wherein the one or more processors, upon execution of the instructions, are configured to perform acts comprising:
obtaining a first domain image and a second domain image, wherein the first domain image and the second domain image are unpaired images in different domains;
obtaining a scaled first domain image by scaling, at an iteration, the first domain image;
obtaining a training patch by cropping the scaled first domain image; and
inputting the training patch into the neural network at the iteration, and outputting an output patch.

15. The apparatus of claim 14, wherein the first domain image comprises a digital avatar image and the second domain image comprises a real-person photo,
wherein the method further comprises: scaling the first domain image based on a random scaling factor in a pre-determined range.

16. The apparatus of claim 15, wherein the one or more processors are configured to perform acts further comprising:
selecting a query sub-patch from the training patch;
selecting a positive sub-patch from the output patch, wherein the positive sub-patch is corresponding to the query sub-patch;
selecting a plurality of negative sub-patches from the training patch, wherein the plurality of negative sub-patches are different than the query sub-patch; and
calculating a contrastive loss based on the query sub-patch, the positive sub-patch, and the plurality of negative sub-patches.

17. The apparatus of claim 16, wherein the one or more processors are configured to perform acts further comprising:
obtaining a scaled second domain image by scaling, at the iteration, the second domain image based on the random scaling factor;
obtaining a second domain patch by cropping the scaled second domain image;
calculating a generative adversarial network (GAN) loss based on the output patch and the second domain patch; and
updating model parameters of the neural network based on the contrastive loss and the GAN loss.

18. The apparatus of claim 16, wherein each training patch selected from the scaled first domain image has a same number of pixels with different contents resulted from scaling the first domain image based on the random scaling factor and cropping the scaled first domain image by using a fixed size.

19. The apparatus of claim 17, wherein each training patch indicates partial features in the first domain image comprising the training patch.

20. The apparatus of claim 17, wherein obtaining the training patch by cropping the scaled first domain image comprises:
determining a starting position on the scaled first domain image; and
obtaining the training patch according to the starting position and the same number of pixels in each training patch.

21. An apparatus for processing an image, comprising:
one or more processors; and
a memory configured to store instructions executable by the one or more processors;
wherein the one or more processors, upon execution of the instructions, are configured to perform acts comprising:
obtaining a face-aligned image by transforming an original image using a transformation matrix and obtaining a coordinated mask image by transforming a mask image using an inverse matrix of the transformation matrix;
obtaining an eroded mask image by eroding the coordinated mask image;
inputting the face-aligned image into a neural network, outputting an output image, and obtaining a back-projected output image by back projecting the output image using the inverse matrix, wherein the neural network is trained by patch-wise contrastive learning based on unpaired images in different domains; and
generating a final image based on pixel values in the eroded mask image, the back-projected output image, and the original image.

22. The apparatus of claim 21, wherein each pixel value in the final image is obtained by following equation:
F=M×O+(1−M)×A
wherein F denotes a value of a pixel in the final image, M denotes a value of a corresponding pixel in the eroded mask image, O denotes a value of a corresponding pixel in the back-projected output image, and A denotes a value of a corresponding pixel in the original image.

23. The apparatus of claim 21, wherein the neural network is trained with the patch-wise contrastive learning based on unpaired images in different domains comprising:
obtaining a first domain image and a second domain image, wherein the first domain image and the second domain image are unpaired images in different domains;
obtaining a scaled first domain image by scaling, at an iteration, the first domain image;
obtaining a training patch by cropping the scaled first domain image; and
inputting the training patch into the neural network at the iteration, and outputting an output patch.

24. The apparatus of claim 23, wherein the first domain image comprises a digital avatar image and the second domain image comprises a real-person photo,
wherein the neural network is further trained by scaling the first domain image based on a random scaling factor in a pre-determined range.

25. The apparatus of claim 24, wherein the neural network is further trained by:
selecting a query sub-patch from the training patch;
selecting a positive sub-patch from the output patch, wherein the positive sub-patch is corresponding to the query sub-patch;
selecting a plurality of negative sub-patches from the training patch, wherein the plurality of negative sub-patches are different than the query sub-patch;
obtaining a scaled second domain image by scaling, at the iteration, the second domain image based on the random scaling factor;
obtaining a second domain patch by cropping the scaled second domain image;
calculating a generative adversarial network (GAN) loss based on the output patch and the second domain patch; and
updating model parameters of the neural network based on the contrastive loss and the GAN loss.

26. The apparatus of claim 24, wherein each training patch selected from the scaled first domain image has a same number of pixels with different contents resulted from scaling the first domain image based on the random scaling factor and cropping the scaled first domain image by using a fixed size.

27. A non-transitory computer readable storage medium, comprising instructions stored therein, wherein, upon execution of the instructions by one or more processors, the instructions cause the one or more processors to perform acts comprising:
obtaining a first domain image and a second domain image, wherein the first domain image and the second domain image are unpaired images in different domains;
obtaining a scaled first domain image by scaling, at an iteration, the first domain image;
obtaining a training patch by cropping the scaled first domain image; and
inputting the training patch into the neural network at the iteration, and outputting an output patch.

28. A non-transitory computer readable storage medium, comprising instructions stored therein, wherein, upon execution of the instructions by one or more processors, the instructions cause the one or more processors to perform acts comprising:
obtaining a face-aligned image by transforming an original image using a transformation matrix and obtaining a coordinated mask image by transforming a mask image using an inverse matrix of the transformation matrix;
obtaining an eroded mask image by eroding the coordinated mask image;
inputting the face-aligned image into a neural network, outputting an output image, and obtaining a back-projected output image by back projecting the output image using the inverse matrix, wherein the neural network is trained by patch-wise contrastive learning based on unpaired images in different domains; and
generating a final image based on pixel values in the eroded mask image, the back-projected output image, and the original image.
